(19) United States
(12) Patent Application Publication
(10) Pub. No.: US 2006/0168284 A1
(43) Pub. Date: Jul. 27, 2006

(54) Multimedia file format

(75) Inventor: Ole-Ivar Holthe, Agdenes (NO)

Correspondence Address: LUMEN INTELLECTUAL PROPERTY SERVICES, INC., 2345 YALE STREET, 2ND FLOOR, PALO ALTO, CA, 94306, US

(73) Assignee: Gidmedia Technologies AS, Agdenes (NO)

(21) Appl. No.: 10/524,742

(22) PCT Filed: Sep. 26, 2003
(86) PCT No.: PCT/NO03/00325

§ 371 Date: Oct. 3, 2005

(30) Foreign Application Priority Data
Sep. 27, 2002 (NO) 20024640

(51) Int. Cl. G06F 15/16

(52) U.S. Cl. 709/231

(57) ABSTRACT

A computerized method of encapsulating multimedia content data, multimedia content description data, and program instruction code into an aggregated data representation comprising a logical structure comprises: storing on a storage device, information about the multimedia content data, the multimedia content description data, and the program instruction code to form a main header section (300) in the logical structure; storing on the storage device, multiple block headers for all multimedia content data, multimedia content description data, and the program instruction code to form a block headers section (301) in the logical structure; and storing on the storage device, multiple data blocks for all multimedia content data, multimedia content description data, and the program instruction code to form a data blocks section (302) in the logical structure.

### CROSS-REFERENCE TO RELATED APPLICATIONS

This application is the US national phase of international application PCT/NO03/00325 filed 26 Sep. 2003, which claims priority from Norwegian patent application number 20024640 filed 27 Sep. 2002, both of which are incorporated herein by reference.

### FIELD OF THE INVENTION

The present invention relates generally to data processing systems, and more particularly to a format for holding and/or describing multimedia content that may include program instruction code for controlling the playback of the multimedia content.

### BACKGROUND OF THE INVENTION

There are many file and/or stream formats in the technical field of the present invention. To mention a few:

The HTML standard

The MPEG-4 standard

Apple QuickTime Format (U.S. Pat. No. 5,751,281)

Microsoft ASF Format (U.S. Pat. No. 6,041,345)

Macromedia SWF Format (http://www.openswf.org)

These formats are typically used to hold and describe multimedia content for use on the Internet. The file or stream based on the format is transmitted over a network to a destination computer containing a renderer, which process and renders the content. Historically these formats were typically designed and implemented for destination computers with good hardware resources (CPU, memory, disk, graphics card, etc.), such as personal computers (PCs). Typically, most of these formats support media types, such as images and text. Some support video, audio, and 3D graphics.

Conventional file and/or stream formats for holding and/or describing multimedia content that may include program instruction code for controlling the playback of the multimedia content, are limited in several respects. First, these formats typically do not consider that the content may need to be used on any class of computer, from computers with very limited hardware resources (CPU, memory, disk, graphics card, etc.), to computers with powerful hardware resources. Such formats, typically require a renderer implementation that will be too large in amount of disk or memory taken up by its program instruction code, or use too much of the hardware resources, for computers with very limited hardware resources (such as handheld devices). Another limitation of such formats is that they are generally limited in the lack of flexibility for representing different media types. Such formats use quite limited predefined multimedia content types. They typically do not support real 3D graphics (textured polygon mesh), which is important with respect to illustrating physical objects in a multimedia rendering.

Yet another limitation of such formats is that they typically cannot contain different levels of content scaling for different destination computers. Computers with limited resources may not be able to render complex multimedia content combinations. Computers with a slow network connection may not be able to download/stream large amounts of multimedia data, such as video and audio. With content scaling, it is possible to maintain multiple representations of the same content for different destination computers. A further weakness of these formats is that they do not provide the compactness that is necessary for rapid transmission over transport mediums. Such formats do not provide streaming capabilities, so that the destination renderers can render the multimedia content while the multimedia content is being transmitted over the transport medium.

### SUMMARY OF THE INVENTION

A format is defined and adopted for a logical structure that encapsulates and/or describes multimedia content that may include program instruction code for controlling the playback of the multimedia content. The multimedia content may be of different media. The data of the multimedia content is partitioned into blocks that are suitable for transmission over a transport medium. The blocks may include description of the multimedia content and/or the multimedia content data. The blocks may also include program code that may be interpreted and/or executed on the destination renderers. The blocks may be compressed and/or encrypted.

The invention includes a computer system that has a logical structure for encapsulating multimedia content that are partitioned into blocks for holding and/or describing the multimedia content that may include program instruction code for controlling the playback of the multimedia content. A computerized method for creating, transmitting, and rendering the content, based on the logical structure, is also included.

In accordance with a first aspect, the invention provides: a method, in a computer system, of encapsulating multimedia content data, multimedia content description data, and program instruction code into an aggregated data representation comprising a logical structure, the method comprising storing on a storage device, information about the multimedia content data, the multimedia content description data, and the program instruction code to form a main header section in the logical structure; storing on the storage device, multiple block headers for all multimedia content data, multimedia content description data, and the program instruction code to form a block headers section in the logical structure; and storing on the storage device, multiple data blocks for all multimedia content data, multimedia content description data, and the program instruction code to form a data blocks section in the logical structure.

In a preferred embodiment the method further comprising determining the storing order of the resources, for the different multimedia types, e.g. audio, video, image and text, providing efficient streaming transmission; compressing the data in some of the data blocks section using appropriate compression schemes, e.g. as ZLIB, PNG or JPEG; and providing different scaled content representations of one or more scenes, depending on different hardware profiles of the destination computers, e.g. bitrate, screen, language, and/or machine.

In a further embodiment the aggregated data representation or the logical structure are transferred across a transport medium to one or more destination computers. Linking between multiple files with multimedia content may be accomplished by using an external_link field in the block headers section.

According to a second aspect, the invention provides, in a computer system, a method of retrieving multimedia content data, multimedia content description data, and program instruction code from an aggregated data representation stored on a storage device, the data representation comprising a logical structure encapsulating the multimedia content data, multimedia content description data, and program instruction code. The method comprising reading from the storage device a main header section of the logical structure, the main header section having information about the multimedia content data, the multimedia content description data, and the program instruction code; multiple header blocks from the header section of the logical structure, the multiple block headers comprising information about multimedia content data, multimedia content description data, and program instruction code; and multiple data blocks from the data section in the logical structure, the multiple data blocks comprising multimedia content data, multimedia content description data, and program instruction code.

The method may further comprise receiving the aggregated data representation or the logical structure across a transport medium on a destination computer, for immediately, or at a later time, rendering the content using a renderer.

In an embodiment the block headers sections comprising a scene block header; the block headers sections comprising an image resource block header, a text resource block header, a mesh resource block header, or a video resource block header; the data blocks section comprising a scene data block; the data blocks section comprising an image resource data block, a text resource data block, a mesh resource data block, or a video resource data block; the number of data blocks in the data blocks section is equal to the number of block headers in the block headers section with an empty external_link field; and the program instruction code controls playback of the multimedia content. The logical structure may be a XML formatted structure.

In a third aspect the invention provides a computer-readable aggregated data representation encapsulating multimedia content data, multimedia content description data, and program instruction code, the aggregated data representation comprising a logical structure stored on a computer readable storage device, the logical structure comprising: a main header section comprising information about the multimedia content data, multimedia content description data, and program instruction code in a logical structure that defines the aggregated data representation; a block header section comprising multiple block headers for the multimedia content data, multimedia content description data, and program instruction code; and a data block section comprising multiple data blocks for all multimedia content data, multimedia content description data, and program instruction code. The logical structure may also in this case be a XML formatted structure.

The invention also provides in a further aspect a computer-readable storage medium holding instructions for encapsulating multimedia content data, multimedia content description data, and program instruction code into an aggregated data representation comprising a logical structure, according to the method of encapsulating as outlined above. Further in another aspect the invention provides a computer-readable storage medium holding instructions for retrieving multimedia content data, multimedia content description data, and program instruction code from an aggregated data representation stored on a storage device, the data representation comprising a logical structure encapsulating the multimedia content data, multimedia content description data, and program instruction code, the instructions comprising reading from the storage device: a main header section of the logical structure, the main header section having information about the multimedia content data, the multimedia content description data, and the program instruction code; multiple header blocks from the header section of the logical structure, the multiple block headers comprising information about multimedia content data, multimedia content description data, and program instruction code; and multiple data blocks from the data section in the logical structure, the multiple data blocks comprising multimedia content data, multimedia content description data, and program instruction code.

The present invention employs a format (GX) for holding and/or describing multimedia content that may include program instruction code for controlling the playback of the multimedia content. A GX file/stream may also be referred to as a GX movie. A GX movie may contain one or more scenes, and/or one or more resources, contained in a block-based structure. A scene specifies the content description and layout data, and/or the program instruction code for controlling the playback of the multimedia content. A resource may hold specific data items, such as images, text, video, etc. FIG. 14 shows an example of two GX files (1400 and 1401). File 1 contains one image resource (“Image resource 1”), one scene (“Scene 1”), and links to two resources in File 2. File 2 contains one image resource (“Image resource 2”) and (“Text resource 2”).

GX is well suited for efficient use on any class of computer, from computers with very limited hardware resources (e.g. handheld devices like mobile phones, PDA's and set-top boxes for Interactive TV), to computers with powerful hardware resources. GX uses a block-based format for holding and/or describing multimedia content. Since the block-based format is relatively flat and un-complex, in its data structure organization, is easy to process and render on the destination computer. This results in a very small renderer implementation, and very low use of hardware resources, on the destination computer.

GX is flexible with respect to the different media types and/or program code types that it may contain. The block-based structure of the format makes it easy to extend with a vast variety of media types. Depending on the value of the type field, the header and data blocks may contain a large number of different media types, limited only by the different renderer implementations. GX provides good support for content scaling. The author can scale the scene with respect to bitrate (bandwidth), language (Norwegian, English, etc.), screen (resolution, refresh rate, etc.), and machine (computer class). Furthermore the author may split the scaled content into multiple files that are linked together using an external_link field, which is important for rapid loading of a specific content scaling by the destination renderer. See example in FIG. 14. The figure illustrates two GX files that are linked together using the external_link.

GX is very efficient with respect to compactness in holding multimedia content. The individual blocks, or data in the blocks, may use different compression schemes, such as ZLIB, PNG, or JPEG compression. The author may specify which compression scheme to use in the content creation process.

GX provides streaming transmission, so that the destination renderers can render the multimedia content while the multimedia content is being transmitted over the transport medium. GX uses resources to store the different media types, which the scenes use. See examples in FIGS. 5, 6, 12, and 13. The figures illustrate how one can contain the multimedia content types; image, text, mesh, and video, as resources, using block headers and data blocks. The resources may be stored in any order by the content creation process, which gives the content author the ability to specify in which order the resources should be loaded, when streamed over a transmission medium. This is very important on slow transport mediums. See example in FIG. 14. The figure illustrates two GX files that are linked together using the external_link. The two example files contain resources that are ordered, and linked together, for efficient streaming transmission.

### BRIEF DESCRIPTION OF THE DRAWINGS

Embodiments of the present invention will now be described with reference to the following drawings, where:

FIG. 1 is a block diagram illustrating a computer system that is suitable for practicing the present invention,

FIG. 2 is a flowchart illustrating use of the GX format in accordance with an embodiment of the present invention,

FIG. 3 is a block diagram illustrating the components of the GX format in accordance with an embodiment of the present invention,

FIG. 4 is a block diagram illustrating the format of the scene_block_header in accordance with an embodiment of the present invention,

FIG. 5 is a block diagram illustrating the format of the image_resource_block_header and the text_resource_block_header in accordance with an embodiment of the present invention,

FIG. 6 is a block diagram illustrating the format of the mesh_resource_block_header and the video_resource_block_header in accordance with an embodiment of the present invention,

FIG. 7 is a block diagram illustrating the format of the scene_data_block in accordance with an embodiment of the present invention,

FIG. 8 is a block diagram illustrating the format of the image data in accordance with an embodiment of the present invention,

FIG. 9 is a block diagram illustrating the format of the text_data in accordance with an embodiment of the present invention,

FIG. 10 is a block diagram illustrating the format of the mesh_data in accordance with an embodiment of the present invention,

FIG. 11 is a block diagram illustrating the format of the video_data in accordance with an embodiment of the present invention,

FIG. 12 is a block diagram illustrating the format of the image_resource_data_block and the text_resource_data_block in accordance with an embodiment of the present invention,

FIG. 13 is a block diagram illustrating the format of the mesh_resource_data_block and the video_resource_data_block in accordance with an embodiment of the present invention, and

FIG. 14 is a block diagram illustrating an example of two GX files.

### DETAILED DESCRIPTION

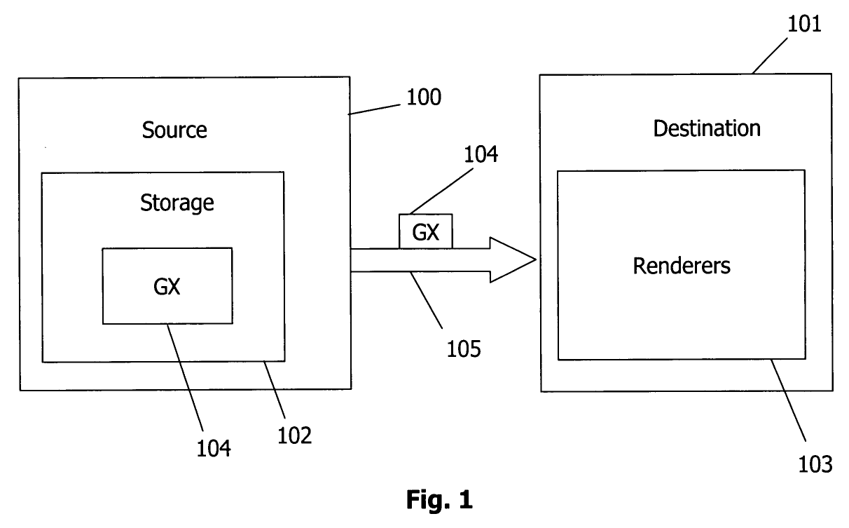

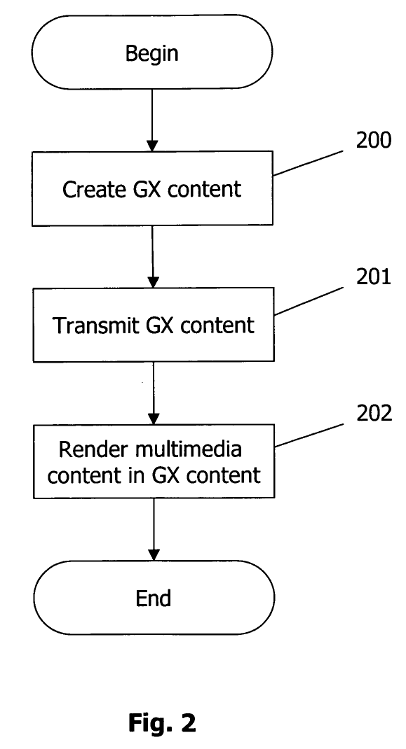

FIG. 1 is a block diagram of an illustrative system for practicing an embodiment of the present invention. The present invention can be practiced on computers with very limited hardware resources (CPU, memory, disk, graphics card, etc.), to computers with powerful hardware resources. Computers with limited hardware resources may be set-top boxes for Interactive TV and handheld devices like cellular phones, PDA's and other devices with CPU and memory, and also PC's with CPU, memory, disk, graphics card, and input and output units. FIG. 2 is a flowchart that illustrates the steps that are performed in the illustrative embodiment of FIG. 1. The file content, hereinafter called GX content (104), is built by an author (step 200 in FIG. 2) and stored on a storage medium (102) on a source computer (100). Sometime later, the GX content (104) is transferred over a transport media (105), such as a network connection, to a destination computer (101) (step 201 in FIG. 2). The destination computer (101) includes a number of renderers (103) for rendering the multimedia content that are present within the GX content (104). For example, the GX content (104) may include program code, image-type data and text-type data. The renderers (103) at the destination (101) include a program code interpreter, an image renderer and a text renderer. The interpreter and the renderers may begin rendering data as soon as they receive data prior to the complete transmission of the entire GX content (104) (see step 202 in FIG. 2). The interpreters and the renderers need not immediately render the data, but rather may render the data at a later point in time.

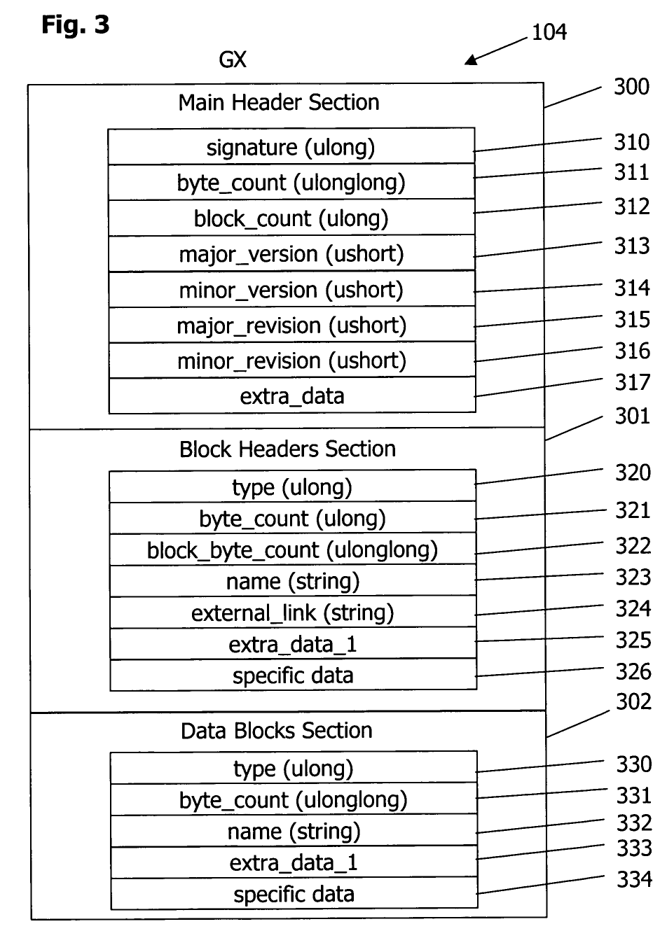

FIG. 3 depicts the basic logical organization of GX content (104). It is up to the author to fill in the contents of the GX content in accordance with this format. The GX content (104) is divisible into a main header section (300), a block headers section (301) and a data blocks section (302). In general, the header sections (300 and 301) are first transmitted from the source computer (100) to the destination computer (101) so that the destination computer may process the information within the header section. Subsequently, the data blocks section (302) is transmitted from the source computer (100) to the destination computer (101) on a block-by-block basis.

The main header section (300) as illustrated in FIG. 3 contains information about the GX content (104). The signature (310) specifies the main type of the GX content, and is typically a large number that is unique for a specific authoring environment. The byte_count (311) specifies the total number of bytes contained in the GX content (104). The block_count (312) specifies the total number of blocks (external or internal) contained in, or used, by the GX content (104). The major_version (313), minor_version (314), major_revision (315), and minor_revision (316) specifies the version of the GX content format. The extra_data (317) provides extra information about the GX content (104), depending on the specific implementation of the GX format. The extra_data (317) is optional, and may consist of a variable number of bytes, depending on the specific implementation.

Examples of possible data types are indicated in the figures. Here we use abbreviations for data types as specified in the C++-programming language. “ulong” is short for “unsigned long”, “ushort” is short for “unsigned short”, “bool” is short for “boolean”, “string” starts with a unsigned long value indicating the byte count of the string followed by the bytes of the UTF-8 character string, “ulonglong” is a 64-bit unsigned long. The invention is not limited to the C++ programming language. Other programming languages may also be used.

The block headers sections (301) as illustrated in FIG. 3 contain a number of block headers that provide information about the GX content (104). The number of block headers is specified by block_count (312) in the main header section (300). The information contained in a block header may vary, depending on the type of content that it describes. A block header will always begin with the fields as indicated in FIG. 3. The type (320) indicates the type of content that the header describes; this can for example indicate a scene, an image resource, or a text resource. The byte_count (321) specifies the total number of bytes in the block header. The block_byte_count (322) specifies the total number of bytes in the associated data block. The name (323) specifies the name of the content item. The external_link (324) specifies a link to the external GX content, in which the associated data block is contained. The external_link is empty if the associated data block is contained in the current GX content. The extra_data_{—}1 (325) provides extra information about the block header and/or content item, depending on the specific implementation of the GX format. The extra_data_{—}1 (325) is optional, and may consist of a variable number of bytes, depending on the specific implementation. The specific data (326) may contain additional information about the content item.

The data blocks section (302) as illustrated in FIG. 3 contain a number of data blocks that contain the data of the content items in the GX content. The number of data blocks in the GX content is equal to the number of block headers in the GX content with an empty external_link. There exists exactly one data block for each block header with an empty external_link in the GX content. The data blocks are specified in the same order, and are of the same content type, as the block headers. The type (330) indicates the type of content that the data block contains; this can for example indicate a scene, an image resource, or a text resource. The byte_count (331) specifies the total number of bytes in the data block. The name (332) specifies the name of the content item. The extra_data_{—}1 (333) provides extra information about the data block and/or content item, depending on the specific implementation of the GX format. The extra_data_{—}1 (333) is optional, and may consist of a variable number of bytes, depending on the specific implementation. The specific data (334) may contain additional information about the content item.

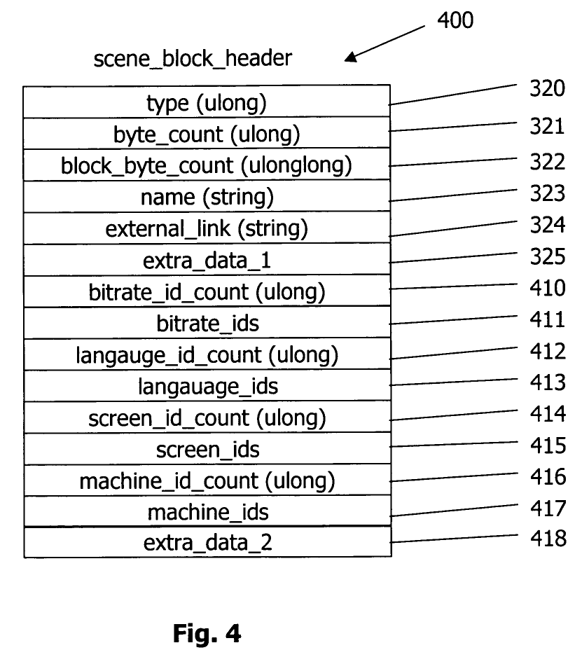

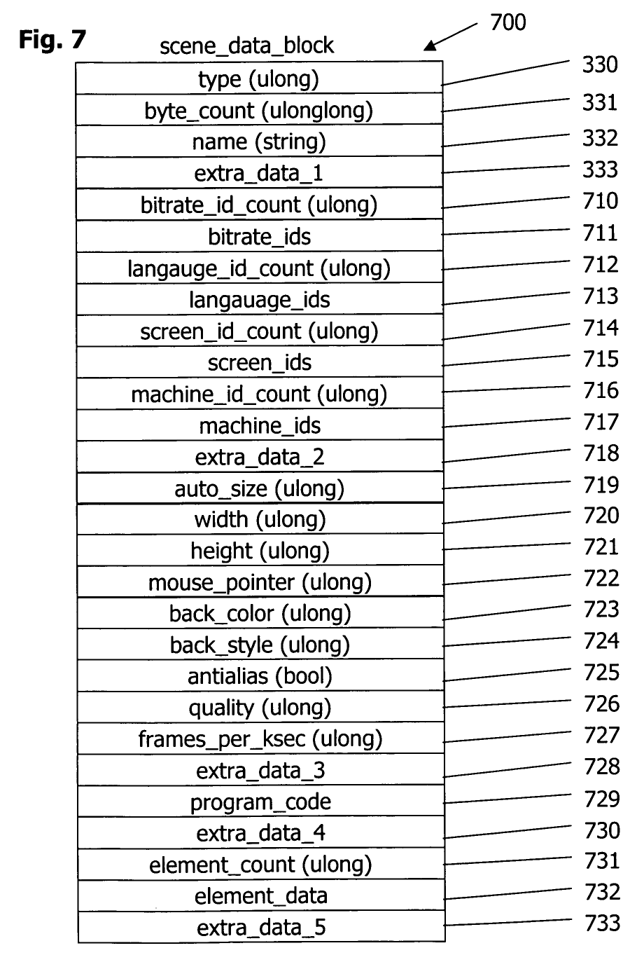

The scene content type can be used in GX content to represent the visual layout of multiple content items of different types. There can be multiple scenes in one GX file. The scene can also be scaled (content scaling) by the renderers (103) for different representations depending on the characteristics of the destination computer (101). The scene_block_header (400) as illustrated in FIG. 4 contains the block header data for the associated scene data block. The scene_data_block (700) as illustrated in FIG. 7 contains the scene data. The type (320 and 330) indicates that the type of the content item is of the scene content type. The bitrate_ids (411 and 711) specifies the bitrate identifiers used for content scaling. The bitrate_id_count (410 and 710) specifies the number of bitrate identifiers. The language_ids (413 and 713) specifies the language identifiers used for content scaling. The language_id_count (412 and 712) specifies the number of language identifiers. The screen_ids (415 and 715) specifies the screen identifiers used for content scaling. The screen_id_count (414 and 714) specifies the number of screen identifiers. The machine_ids (417 and 717) specifies the machine identifiers used for content scaling. The machine_id_count (416 and 716) specifies the number of machine identifiers. The bitrate_ids, language_ids, screen_ids, and machine_ids, may in an embodiment be of the unsigned long data type. The extra_data_{—}2 (418 and 718) provides extra information about the scene block and/or content item, depending on the specific implementation of the GX format. The extra_data_{—}2 (418 and 718) is optional, and may consist of a variable number of bytes, depending on the specific implementation. The auto_size (719) specifies the layout of the scene inside the scene container. The width (720) and height (721) specifies the size of the scene. The mouse_pointer (722) specifies how the mouse pointer shall appear on the scene. The back_color (723) specifies the background color of the scene. The back_style (724) specifies the background style of the scene. The antialias (725) specifies antialiasing for the scene. The quality (726) specifies the quality of the scene rendering. The frames_per_ksec (727) specifies the frame-rate of the scene rendering. The program_code (729) specifies the program code of the scene. The program_code may begin with an unsigned long value indicating the byte count of the program code, and may be followed by the bytes of the program. The element_count (731) specifies the byte count of the element data. The element_data (732) contains element definitions for the scene. The extra_data_{—}3 (728), extra_data_{—}4 (730), and extra_data_{—}5 (733) provide extra information about the scene, depending on the specific implementation of the GX format. The extra_data_{—}3 (728), extra_data_{—}4 (730), and extra_data_{—}5 (733) are optional, and may consist of a variable number of bytes, depending on the specific implementation. The program_code (729) can be in any programming language or instruction-set, compiled or source code, depending on the specific implementation.

The program code uses the classes; Scene, Image, Text, Mesh, Video, etc., as specified in the Java-language in Appendix B. The classes may implement additional functionality, and that there may be more classes, depending on the specific implementation.

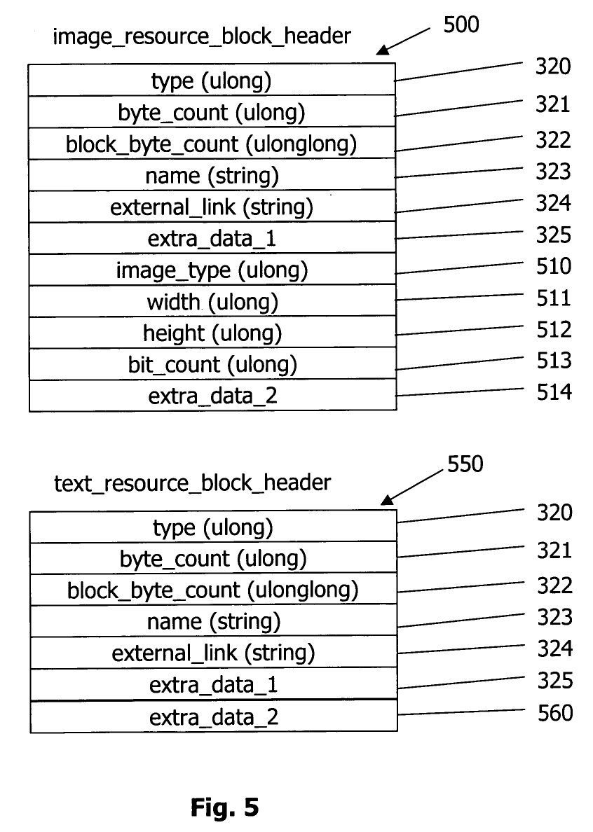

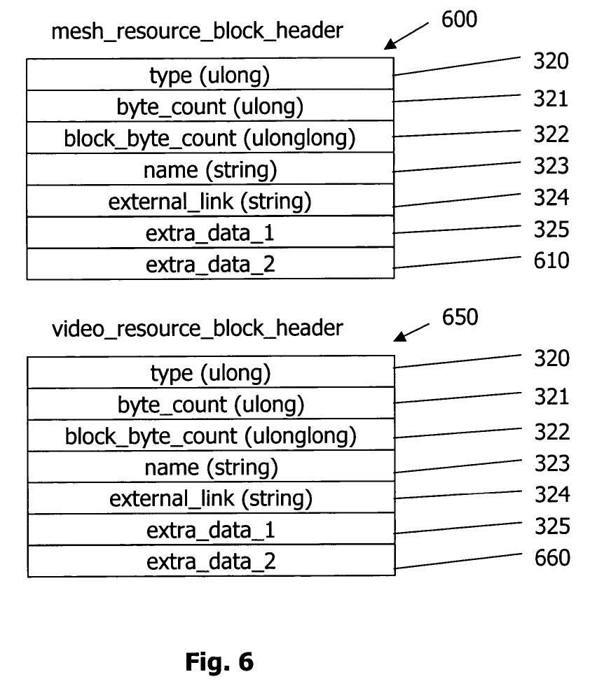

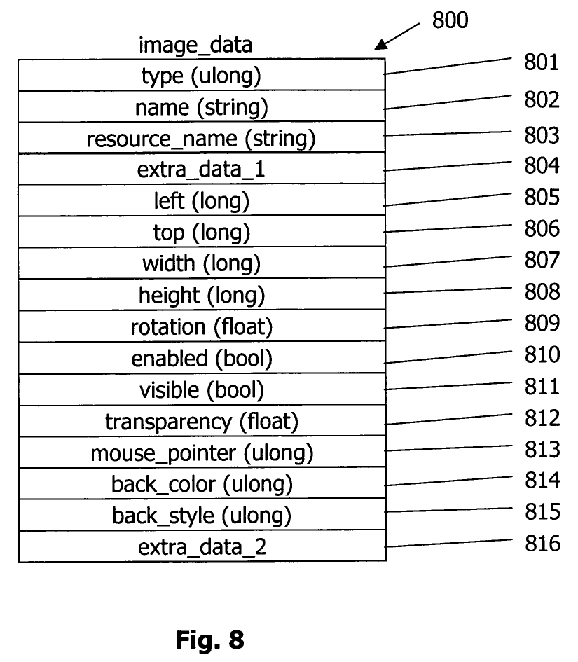

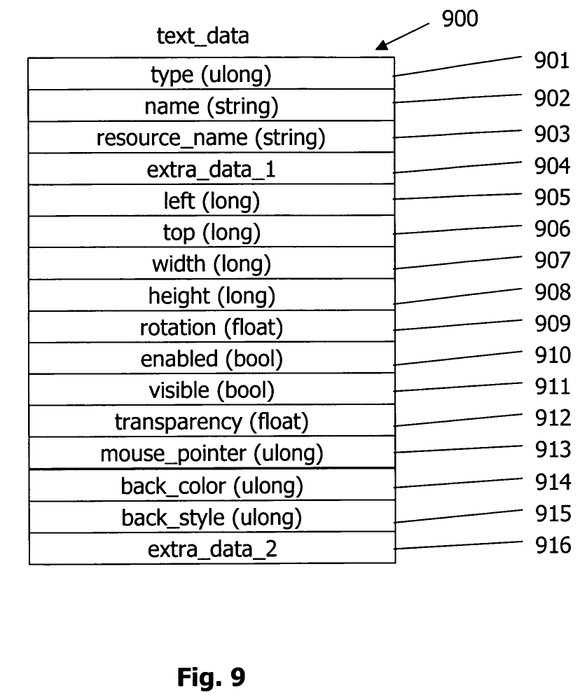

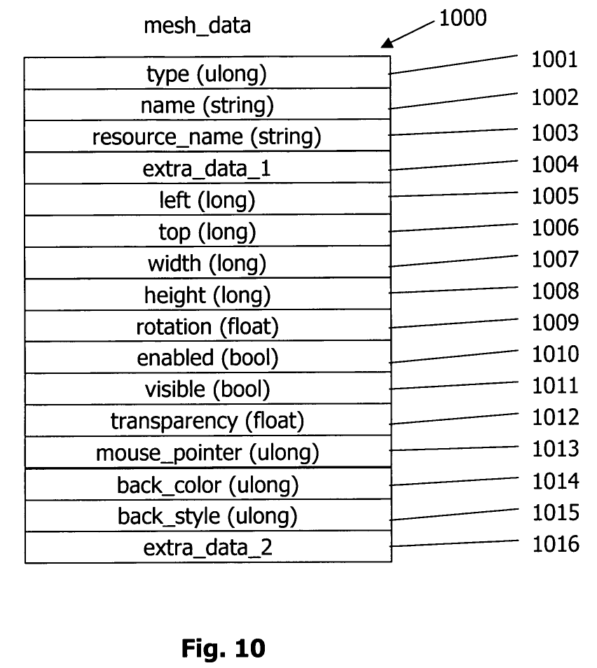

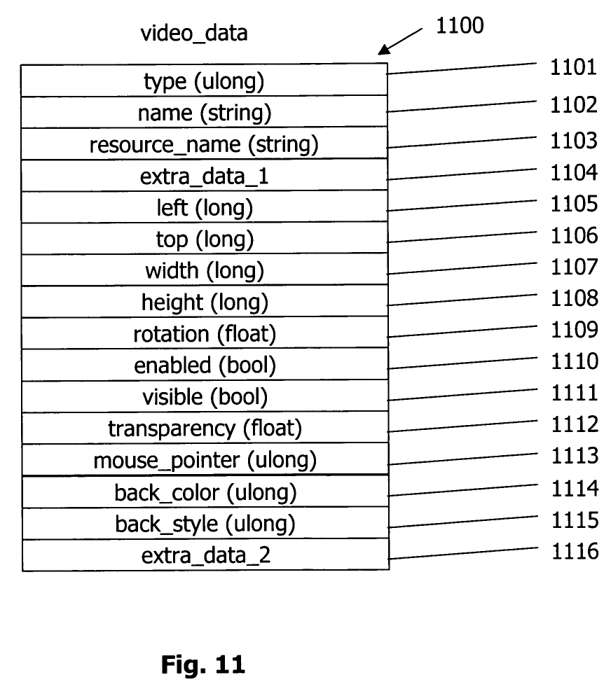

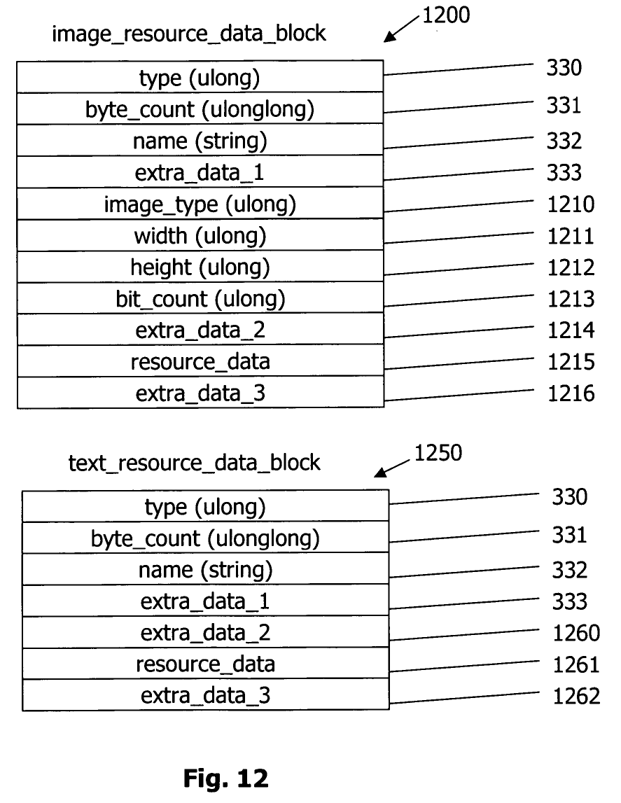

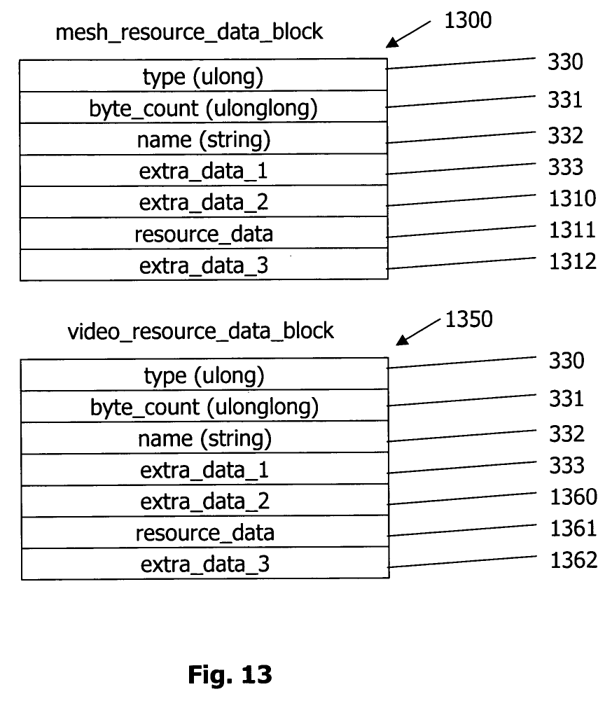

The image_data (800) as illustrated in FIG. 8 contain element definition data for the scene of the image element type. The text_data (900) as illustrated in FIG. 9 contain element definition data for the scene of the text element type. The mesh_data (1000) as illustrated in FIG. 10 contain element definition data for the scene of the mesh element type. The video_data (1100) as illustrated in FIG. 11 contain element definition data for the scene of the video element type. The image_data (800), text_data (900), mesh_data (1000), and video_data (1100) may be contained in the element_data (732) of the scene. The left (805, 905, 1005, 1105), top (806, 906, 1006. 1106), width (807, 907, 1007, 1107), and height (808, 908, 1008, 1108) specify the position and size of the element. The rotation (809, 909, 1009, 1109) specifies the rotation of the element. The enabled (810, 910, 1010, 1110) specifies whether the element is enabled or disabled. The visible (811, 911, 1011, 1111) specifies whether the element is visible. The transparency (812, 912, 1012, 1112) specifies the transparency of the element. The mouse_pointer (813, 913, 1013, 1113) specifies how the mouse pointer shall appear on the element. The back_color (814, 914, 1014, 1114) specifies the background color of the element. The back_style (815, 915, 1015, 1115) specifies the background style of the element. The extra_data_{—}1 (804, 904, 1004, 1104), and extra_data_{—}2 (816, 916, 1016, 1116) provide extra information about the element, depending on the specific implementation of the GX format. The extra_data_{—}1 (804, 904, 1004, 1104), and extra_data_{—}2 (816, 916, 1016, 1116) are optional, and may consist of a variable number of bytes, depending on the specific implementation. The image, text, mesh and/or video resource can be used in GX content to contain image, text, 3D mesh and/or video data, respectively. The image_resource_block_header (500) as illustrated in FIG. 5 contains the block header data for the associated image resource data block. The image_resource_data_block (1200) as illustrated in FIG. 12 contains the image resource data. The text_resource_block_header (550) as illustrated in FIG. 5 contains the block header data for the associated text resource data block. The text_resource_data_block (1250) as illustrated in FIG. 12 contains the text resource data. The mesh_resource_block_header (600) as illustrated in FIG. 6 contains the block header data for the associated mesh resource data block. The mesh_resource_data_block (1300) as illustrated in FIG. 13 contains the mesh resource data. The video_resource_block_header (650) as illustrated in FIG. 6 contains the block header data for the associated video resource data block. The video_resource_data_block (1350) as illustrated in FIG. 13 contains the video resource data. The image_type (510 and 1210) specifies the type of the image data. The width (511 and 1211) and height (512 and 1212) specifies the size of the image. The bit_count (513 and 1213) specifies the number of bits per pixel of the image. The resource_data (1215, 1261, 1311, 1361) specifies the data of the resource. The resource_data may begin with an unsigned long value indicating the byte count of the resource data, and may be followed by the bytes of the resource data. The extra_data_{—}2 (514, 560, 610, 660, 1214, 1260, 1310, 1360), and extra_data_{—}3 (1216, 1262, 1312, 1362) provide extra information about the resource, depending on the specific implementation of the GX format. The extra_data_{—}2 (514, 560, 610, 660, 1214, 1260, 1310, 1360), and extra_data_{—}3 (1216, 1262, 1312, 1362) are optional, and may consist of a variable number of bytes, depending on the specific implementation.

The World Wide Web Consortium (W3C) has defined the Extensible Markup Language (XML) universal format for structured documents and data on the Web. It is easy to see that the GX format can easily be represented using XML. Appendix A shows a XML Schema (XSD), for representing the GX format, according to the W3C XSD specifications. Program code listing A.2 is an example XML document, containing GX formatted content in XML format, based on the XML Schema. The XSD specification in program code listing A.1 specifies the preferred XML representation of GX formatted content (GXML). The GXML document may be in text or binary coded form. Typically, GXML will be used with more functionality (elements, attributes, etc.) than what is specified by the XML Schema in program code listing A.1. Any element type in GXML may include more elements and attributes that what is specified by the XML Schema (e.g. include elements from other XML Schema types). For certain applications, it might be preferable to do modest restructuring and/or use different names on some of the elements and attributes to accommodate the terminology of the specific application contexts.

The “<gxml>” and “</gxml>” tag pair will typically mark the beginning and end of the GXML document. The tag may include additional attributes (e.g. “version” for marking the version). For certain applications, it might be preferable not to include this tag (e.g. when the GXML format is encapsulated in other types of XML documents or schemas) or use a different name that is more appropriate for that particular application.

The “<head>” and “</head>” tag pair will typically mark the beginning and end of the header section of the GXML document. The header section will typically contain information about the content. For certain applications, it might be preferable not to include this tag or to use a different name for this tag that is more appropriate for that particular application (e.g. “Descriptor”, “DescriptorMetadata”, “Description”, “DescriptionMetadata”, “MovieDescriptor”).

The program code listing A.3 is an example of GXML formatted content header where we use the word “Descriptor” rather than “Header”. We have also defined attribute groups, such as “SystemBitRate”, “SystemLanguages”, “SystemScreen”, “SystemMachine”, “Format” and “ExternalURL”. “ExternalURL” will typically use a different name for different applications (e.g. “ExternalLink”, “Locator”, “ExternalLocator”, “ResourceLocator”, “SceneLocator”, “ImageLocator”, “MediaLocator”). It may be preferable to group the descriptors within a “descriptors” tag. For certain applications, the program code listing illustrates a preferred XML representation for the GXML header section.

The program code listing A.4 is an example of GXML formatted content header where we structure the descriptors under the “descriptors” tag, and the external links under the “references” tag. For certain applications, the program code listing illustrates a preferred XML representation for the GXML header section.

The “<movie>” and “</movie>” tag pair will typically mark the beginning and end of the data section of the GXML document. For certain applications, it might be preferable not to include this tag or to use a different name for this tag that is more appropriate for that particular application.

The program code listing A.5 is an example of GXML formatted data section where we have defined attribute groups, such as “Layout”, “Behavior”, and “Appearance”. For certain applications, the program code listing illustrates a preferred XML representation for the GXML data section.

The program code listing A.6 is an example of using GXML in a particular application. In this example the GXML format has been used as a part of the particular format of the application. Such use of formats inside formats is quite common with XML documents.

Including binary data in XML documents have been an industry problem for some time. In GXML we use the “xs:hexBinary” type on “HexBinaryData” elements. Similarly, it is also possible to have the “xs:base64Binary” type on “Base64BinaryData” elements, alternatively to “HexBinaryData”. GXML might also include binary data trailing the XML document.

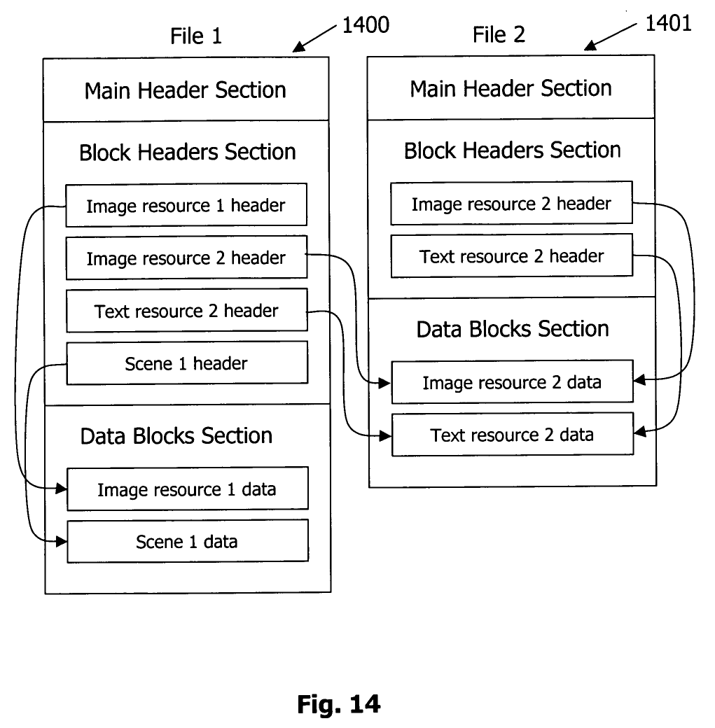

FIG. 14 is an example on how content can be effectively linked together for the purpose of efficient transmission of the multimedia content over a slow transmission medium. Typically, the main problems with a slow transmission medium are; high access time and low transmission rate. The access time is the time from the destination computer requests content, until the destination computer initially receives it. The transmission rate is the rate at which data can be delivered across the transmission medium. The GX format can embed many small content items as resources, which reduces the total content transfer time on transmission mediums with a high access time. As one can see in FIG. 14, the GX files (1400 and 1401) contain multiple data blocks, which contain content items, in each GX file. The arrows in FIG. 14 illustrates content linking, using the external_link (324) field of the block headers. The external_link field indicates where the data block is located, either in the same file, or an external file. The external_link field may be an URL. By linking multimedia content in this manner, one can have efficient reuse of multimedia content between different GX files, while maintaining a minimal number of GX content files. Reuse of multimedia content is important, since it can be used to avoid having to retransmit the same content item multiple times. You do want to avoid retransmission of content items on slow transmission mediums.

While the present invention has been described with reference to an embodiment thereof, those skilled in the art will appreciate that various changes in form and detail may be made without departing from the intended scope of the invention as defined in the appended claims. The particulars described above are intended merely to be illustrative and the scope of the invention is defined by the appended claims. For example, the present invention may be practiced with a multimedia content format that differs from the format described above. Alternative multimedia content formats may include only a subset of the above-described fields or include additional fields that differ from those described above. Moreover, the length of the values held within the fields and the organization of the structures described above are not intended to limit the scope of the present invention.

Appendix A

This appendix contains the code listing for the XSD specification of the GXML format, with an example GXML formatted file.

Program Code Listing A.1:

```
<?xml version=“1.0” encoding=“UTF-8”?>
<xs:schema xmlns:xs=“http://www.w3.org/2001/XMLSchema”
elementFormDefault=“qualified” attributeFormDefault=“unqualified”>
  <xs:element name=“gxml”>
    <xs:annotation>
      <xs:documentation>GXML Document</xs:documentation>
    </xs:annotation>
    <xs:complexType>
      <xs:sequence>
        <xs:element name=“head”>
          <xs:complexType>
            <xs:choice maxOccurs=“unbounded”>
              <xs:element name=“sceneHeader”>
                <xs:complexType>
                  <xs:attribute name=“name” type=“xs:string” use=“required”/>
                  <xs:attribute name=“externalLink” type=“xs:string” use=“optional”/>
                  <xs:attribute name=“bitrateIDs” type=“xs:string” use=“optional”/>
                  <xs:attribute name=“languageIDs” type=“xs:string” use=“optional”/>
                  <xs:attribute name=“screenIDs” type=“xs:string” use=“optional”/>
                  <xs:attribute name=“machineIDs” type=“xs:string” use=“optional”/>
                </xs:complexType>
              </xs:element>
              <xs:element name=“imageResourceHeader”>
                <xs:complexType>
                  <xs:attribute name=“name” type=“xs:string” use=“required”/>
                  <xs:attribute name=“externalLink” type=“xs:string” use=“optional”/>
                  <xs:attribute name=“imageType” type=“xs:integer” use=“optional”/>
                  <xs:attribute name=“width” type=“xs:integer” use=“optional”/>
                  <xs:attribute name=“height” type=“xs:integer” use=“optional”/>
                  <xs:attribute name=“bitCount” type=“xs:integer” use=“optional”/>
                </xs:complexType>
              </xs:element>
              <xs:element name=“textResourceHeader”>
                <xs:complexType>
          <xs:attribute name=“name” type=“xs:string” use=“required”/>
          <xs:attribute name=“externalLink” type=“xs:string” use=“optional”/>
        </xs:complexType>
      </xs:element>
      <xs:element name=“meshResourceHeader”>
        <xs:complexType>
          <xs:attribute name=“name” type=“xs:string” use=“required”/>
          <xs:attribute name=“externalLink” type=“xs:string” use=“optional”/>
        </xs:complexType>
      </xs:element>
      <xs:element name=“videoResourceHeader”>
        <xs:complexType>
          <xs:attribute name=“name” type=“xs:string” use=“required”/>
          <xs:attribute name=“externalLink” type=“xs:string” use=“optional”/>
        </xs:complexType>
      </xs:element>
    </xs:choice>
  </xs:complexType>
</xs:element>
<xs:element name=“movie”>
  <xs:complexType>
    <xs:choice maxOccurs=“unbounded”>
      <xs:element name=“scene”>
        <xs:complexType>
          <xs:sequence>
            <xs:choice minOccurs=“0” maxOccurs=“unbounded”>
              <xs:element name=“image”>
                <xs:complexType>
                  <xs:attribute name=“name” type=“xs:string” use=“required”/>
                  <xs:attribute name=“resourceName” type=“xs:string” use=“optional”/>
                  <xs:attribute name=“left” type=“xs:integer” use=“optional”/>
                  <xs:attribute name=“top” type=“xs:integer” use=“optional”/>
                  <xs:attribute name=“width” type=“xs:integer” use=“optional”/>
                  <xs:attribute name=“height” type=“xs:integer” use=“optional”/>
                  <xs:attribute name=“rotation” type=“xs:float” use=“optional”/>
                  <xs:attribute name=“enabled” type=“xs:boolean” use=“optional”/>
                  <xs:attribute name=“visible” type=“xs:boolean” use=“optional”/>
                  <xs:attribute name=“transparency” type=“xs:float” use=“optional”/>
                  <xs:attribute name=“mousePointer” type=“xs:integer” use=“optional”/>
                  <xs:attribute name=“backColor” type=“xs:integer” use=“optional”/>
                  <xs:attribute name=“backStyle” type=“xs:integer” use=“optional”/>
                </xs:complexType>
            </xs:element>
            <xs:element name=“text”>
              <xs:complexType>
                  <xs:attribute name=“name” type=“xs:string” use=“required”/>
                  <xs:attribute name=“resourceName” type=“xs:string” use=“optional”/>
                  <xs:attribute name=“left” type=“xs:integer” use=“optional”/>
                  <xs:attribute name=“top” type=“xs:integer” use=“optional”/>
                  <xs:attribute name=“width” type=“xs:integer” use=“optional”/>
                  <xs:attribute name=“height” type=“xs:integer” use=“optional”/>
                  <xs:attribute name=“rotation” type=“xs:float” use=“optional”/>
                  <xs:attribute name=“enabled” type=“xs:boolean” use=“optional”/>
                  <xs:attribute name=“visible” type=“xs:boolean” use=“optional”/>
                  <xs:attribute name=“transparency” type=“xs:float” use=“optional”/>
                  <xs:attribute name=“mousePointer” type=“xs:integer” use=“optional”/>
                  <xs:attribute name=“backColor” type=“xs:integer” use=“optional”/>
                  <xs:attribute name=“backStyle” type=“xs:integer” use=“optional”/>
                </xs:complexType>
              </xs:element>
              <xs:element name=“mesh”>
                <xs:complexType>
                  <xs:attribute name=“name” type=“xs:string” use=“required”/>
                  <xs:attribute name=“resourceName” type=“xs:string” use=“optional”/>
                  <xs:attribute name=“left” type=“xs:integer” use=“optional”/>
                  <xs:attribute name=“top” type=“xs:integer” use=“optional”/>
                  <xs:attribute name=“width” type=“xs:integer” use=“optional”/>
                  <xs:attribute name=“height” type=“xs:integer” use=“optional”/>
                  <xs:attribute name=“rotation” type=“xs:float” use=“optional”/>
                  <xs:attribute name=“enabled” type=“xs:boolean” use=“optional”/>
                  <xs:attribute name=“visible” type=“xs:boolean” use=“optional”/>
                  <xs:attribute name=“transparency” type=“xs:float” use=“optional”/>
                  <xs:attribute name=“mousePointer” type=“xs:integer” use=“optional”/>
                  <xs:attribute name=“backColor” type=“xs:integer” use=“optional”/>
                  <xs:attribute name=“backStyle” type=“xs:integer” use=“optional”/>
                </xs:complexType>
              </xs:element>
              <xs:element name=“video”>
                <xs:complexType>
                  <xs:attribute name=“name” type=“xs:string” use=“required”/>
                  <xs:attribute name=“resourceName” type=“xs:string” use=“optional”/>
                  <xs:attribute name=“left” type=“xs:integer” use=“optional”/>
                  <xs:attribute name=“top” type=“xs:integer” use=“optional”/>
                  <xs:attribute name=“width” type=“xs:integer” use=“optional”/>
                  <xs:attribute name=“height” type=“xs:integer” use=“optional”/>
                  <xs:attribute name=“rotation” type=“xs:float” use=“optional”/>
                  <xs:attribute name=“enabled” type=“xs:boolean” use=“optional”/>
                  <xs:attribute name=“visible” type=“xs:boolean” use=“optional”/>
                  <xs:attribute name=“transparency” type=“xs:float” use=“optional”/>
                  <xs:attribute name=“mousePointer” type=“xs:integer” use=“optional”/>
                  <xs:attribute name=“backColor” type=“xs:integer” use=“optional”/>
                  <xs:attribute name=“backStyle” type=“xs:integer” use=“optional”/>
                </xs:complexType>
              </xs:element>
            </xs:choice>
            </xs:element name=“program”>
              <xs:complexType>
                <xs:choice minOcours=“0” maxOccurs=“unbounded”>
                  <xs:element name=“hexBinaryData” type=“xs:hexBinary”/>
                </xs:choice>
                <xs:attribute name=“src” type=“xs:string” use=“optional”/>
              <xs:complexType>
            </xs:element>
          </xs:sequence>
          <xs:attribute name=“name” type=“xs:string” use=“required”/>
          <xs:attribute name=“bitrateIDs” type=“xs:string” use=“optional”/>
          <xs:attribute name=“languageIDs” type=“xs:string” use=“optional”/>
          <xs:attribute name=“screenIDs” type=“xs:string” use=“optional”/>
          <xs:attribute name=“machineIDs” type=xs:string” use=“optional”/>
          <xs:attribute name=“autoSize” type=“xs:integer” use=“optional”/>
          <xs:attribute name=“width” type=“xs:integer” use=“optional”/>
          <xs:attribute name=“height” type=“xs:integer” use=“optional”/>
          <xs:attribute name=“mousePointer” type=“xs:integer” use=“optional”/>
          <xs:attribute name=“backColor” type=“xs:string” use=“optional”/>
          <xs:attribute name=“backStyle” type=“xs:integer” use=“optional”/>
          <xs:attribute name=“antialias” type=xs:integer” use=“optional”/>
          <xs:attribute name=“quality” type=“xs.integer” use=“optional”/>
          <xs:attribute name=“framesPerKSec” type=“xs:integer” use=“optional”/>
        </xs:complexType>
      </xs:element>
      <xs:element name=“imageResource”>
        <xs:complexType>
          <xs:choice minOccurs=“0” maxOccurs=“unbounded”>
                    <xs:element name=“hexBinaryData” type=“xs:hexBinary”/>
                  </xs:choice>
                  <xs:attribute name=“name” type=“xs:string” use=“required”/>
                  <xs:attribute name=“imageType” type=“xs:integer” use=“optional”/>
                  <xs:attribute name=“width” type=“xs:integer” use=“optional”/>
                  <xs:attribute name=“height” type=“xs:integer” use=“optional”/>
                  <xs:attribute name=“bitCount” type=“xs:integer” use=“optional”/>
                  <xs:attribute name=“src” type=“xs:string” use=“optional”/>
                </xs:complexType>
              </xs:element>
              <xs:element name=“textResource”>
                <xs:complexType>
                  <xs:choice minOccurs=“0” maxOccurs=“unbounded”>
                    <xs:element name=“hexBinaryData” type=“xs:hexBinary”/>
                  </xs:choice>
                    <xs:attribute name=“name” type=“xs:string” use=“required”/>
                    <xs:attribute name=“src” type=“xs:string” use=“optional”/>
                </xs:complexType>
              </xs:element>
              <xs:element name=“meshResource”>
                <xs:complexType>
                  <xs:choice minOccurs=“0” maxOccurs=“unbounded”>
                    <xs:element name=“hexBinaryData” type=“xs:hexBinary”/>
                  </xs:choice>
                  <xs:attribute name=“name” type=“xs:string” use=“required”/>
                  <xs:attribute name=“src” type=“xs:string” use=“optional”/>
                </xs:complexType>
              </xs:element>
              <xs:element name=“videoResource”>
                <xs:complexType>
                  <xs:choice minOccurs=“0” maxOccurs=“unbounded”>
                    <xs:element name=“hexBinaryData” type=“xs:hexBinary”/>
                  </xs:choice>
                  <xs:attribute name=“name” type=“xs:string” use=“required”/>
                  <xs:attribute name=“src” type=“xs:string” use=“optional”/>
                </xs:complexType>
              </xs:element>
            </xs:choice>
          </xs:complexType>
        </xs:element>
      </xs:sequence>
    </xs:complexType>
  </xs:element>
</xs:schema>
```

Program Code Listing A.2:

```
<?xml version=“1.0” encoding=“UTF-8”?>
<gxml xmlns:xsi=“http://www.w3.org/2001/XMLSchema-instance”>
  <head>
    <sceneHeader name=“Scene1” externalLink=“” bitrateIDs=“56000” languageIDs=“0”
    screenIDs=“0”/>
    <imageResourceHeader name=“IR_Image1” externalLink=“” imageType=“0” width=“5”
    height=“5” bitCount=“24”/>
  </head>
  <movie>
    <scene name=“Scene1” bitrateIDs=“56000” languageIDs=“0” screenIDs=“0”
    autoSize=“0” width=“550” height=“400” mousePointer=“0” backColor=“0” backStyle=“0”
    antialias=“0” quality=“0” framesPerKSec=“2500”>
      <image name=“Image1” resourceName=“IR_Image1” left=“20” top=“20” width=“5”
      height=“5” rotation=“0” enabled=“true” visible=“true” transparency=“0”
      mousePointer=“0” backColor=“0” backStyle=“0”/>
      <program src=“”>
        <hexBinaryData>0000000000000000000000000fff0fff0fff000000000fff00000fff
        000000000fff0fff0fff000000000000000000000000</hexBinaryData>
      </program>
    </scene>
    <imageResource name=“IR_Image1” imageType=“0” width=“5” height=“5”
    bitCount=“24” src=“”>
      <hexBinaryData>0000000000000000000000000fff0fff0fff000000000fff00000fff
      000000000fff0fff0fff000000000000000000000000</hexBinaryData>
    </imageResource>
  </movie>
</gxml>
```

Program Code Listing A.3:

```
<?xml version=“1.0” encoding=“UTF-8” ?>
<GXML Version=“1.0.0.0”>
  <Head>
    <SceneDescriptor Name=“Scene1”>
      <SystemBitRate Variable=“True” Minimum=“0” Average=“56000” Maximum=“56000”/>
      <SystemLanguages Size=“2”>en-us no</ SystemLanguages>
      <SystemScreen Width=“1024” Height=“768” FrameRate=“60.0” ColorResolution=“32”
Interlaced=“False”/>
      <SystemMachine Platform=“Win32” CPU=“x86”/>
    </SceneDescriptor>
    <SceneDescriptor Name=“Scene2”>
      <SystemBitRate Variable=“True” Minimum=“0” Average=“64000” Maximum=“64000”/>
      <SystemLanguages Size=“2”>en-us no</ SystemLanguages>
      <SystemScreen Width=“1024” Height=“768” FrameRate=“60.0” ColorResolution=“32”
Interlaced=“False”/>
      <SystemMachine Platform=“Win32” CPU=“x86”/>
      <ExternalURL>movie2.gxml</ExternalURL>
    </SceneDescriptor>
    <ImageDescriptor Name=“IR_Image1”>
      <Format Type=“PNG” Width=“5” Height=“5” BitCount=“24”/>
      <ExternalURL>movie2.gxml</ExternalURL>
    </ImageDescriptor>
    <ImageDescriptor Name=“IR_Image2”>
      <Format Type=“PNG” Width=“5” Height=“5” BitCount=“24”/>
      <ExternalURL>image1.png</ExternalURL>
    </ImageDescriptor>
  </Head>
  <Movie>
  ...
  </Movie>
</GXML>
```

Program Code Listing A.4:

```
<?xml version=“1.0” encoding=“UTF-8” ?>
<GXML Version=“1.0.0.0”>
  <Head>
    <Descriptors>
      <SceneDescriptor Name=“Scene1”>
        <SystemBitRate Variable=“True” Minimum=“0” Average=“56000” Maximum=“56000”/>
        <SystemLanguages Size=“2”>en-us no</ SystemLanguages>
        <SystemScreen Width=“1024” Height=“768” FrameRate=“60.0” ColorResolution=“32”
Interlaced=“False”/>
        <SystemMachine Platform=“Win32” CPU=“x86”/>
      </SceneDescriptor>
      <SceneDescriptor Name=“Scene2”>
        <SystemBitRate Variable=“True” Minimum=“0” Average=“64000” Maximum=“64000”/>
        <SystemLanguages Size=“2”>en-us no</ SystemLanguages>
        <SystemScreen Width=“1024” Height=“768” FrameRate=“60.0” ColorResolution=“32”
Interlaced=“False”/>
      <SystemMachine Platform=“Win32” CPU=“x86”/>
    </SceneDescriptor>
      <ImageDescriptor Name=“IR_Image1”>
        <Format Type=“PNG” Width=“5” Height=“5” BitCount=“24”/>
      </ImageDescriptor>
      <ImageDescriptor Name=“IR_Image2”>
        <Format Type=“PNG” Width=“5” Height=“5” BitCount=“24”/>
      </ImageDescriptor>
    </Descriptors>
    <References>
      <Reference Name=“Scene2”>movie2.gxml</Reference>
      <Reference Name=“IR_Image1”>movie2.gxml</Reference>
      <Reference Name=“IR_Image2”>image1.png</Reference>
    </References>
  </Head>
  <Movie>
  ...
  </Movie>
</GXML>
```

Program Code Listing A.5:

```
<?xml version=“1.0” encoding=“UTF-8” ?>
<GXML Version=“1.0.0.0”>
  <Head>
  ...
  </Head>
  <Movie>
    <Scene Name=“Scene1”>
      <Layout AutoSize=“0” Width=“550” Height=“400”/>
      <Appearance Antialias=“false” BackColor=“#000000” BackStyle=“opaque”
Cursor=“arrow” FramesPerSec=“25.0” Quality=“high”/>
      <Image Name=“Image1” Resource=“IR_Image1”>
        <Layout Left=“20” Top=“20” Width=“5” Height=“5” Rotation=“0”/>
        <Behavior Enabled=“true” Visible=“true”/>
        <Appearance Cursor=“arrow” Transparency=“0” BackColor=“#000000”
BackStyle=“opaque”/>
      </Image>
      <Text Name=“Text1”>
        <Layout Left=“40” Top=“20” Width=“100” Height=“100” Rotation=“0”/>
        <Behavior Enabled=“true” Visible=“true”/>
        <Appearance Cursor=“arrow” Transparency=“0” BackColor=“#000000”
BackStyle=“opaque”/>
        <Data>
          <P><Font>Hello World!</Font></P>
        </Data>
      </Text>
      <Program Resource=“” SrcURL=“”>
        <Base64BinaryData>0000000000000000000000000nnn0nnn0nnn
        000000000nnn00000nnn000000000nnn0nnn0nnn0000000000000
        00000000000</Base64BinaryData>
      </Program>
    </Scene>
  </Movie>
</GXML>
```

Program Code Listing A.6:

```
<?xml version=“1.0” encoding=“UTF-8”?>
<Diddle xmlns=“diddle.xsd”
    xmlns:gxml=“gxml.xsd”>
<Container>
  <Descriptor>
    <Statement Type=“text/xml”>
      <gxml:GXML>
        <gxml:SceneDescriptor Name=“Scene1”>
          <gxml:SystemBitRate Variable=“True” Minimum=“0” Average=“56000”
Maximum=“56000”/>
          <gxml:SystemLanguages Size=“2”>en-us no</gxml:SystemLanguages>
          <gxml:SystemScreen Width=“1024” Height=“768” FrameRate=“60.0”
ColorResolution=“32” Interlaced=“False”/>
          <gxml:SystemMachine Platform=“Win32” CPU=“x86”/>
        </gxml:SceneDescriptor>
        <gxml:ImageDescriptor Name=“IR_Image1”>
          <gxml:Format Type=“PNG” Width=“5” Height=“5” BitCount=“24”/>
        </gxml:ImageDescriptor>
        <gxml:ImageDescriptor Name=“IR_Image2”>
          <gxml:Format Type=“PNG” Width=“5” Height=“5” BitCount=“24”/>
          <ImageLocator><MediaUri>movie2.diddle</MediaUri></ImageLocator>
        </gxml:ImageDescriptor>
      </gxml:GXML>
    </Statement>
  </Descriptor>
  <Item>
    <Component>
      <Resource Type=“text/xml”>
        <gxml:GXML>
          <gxml:Scene Name=“Scene1”>
            <gxml:Layout AutoSize=“0” Width=“550” Height=“400”/>
            <gxml:Appearance Antialias=“false” BackColor=“#000000” BackStyle=“opaque”
Cursor=“arrow” FramesPerSec=“25.0” Quality=“high”/>
            <gxml:Image Name=“Image1” Resource=“IR_Image1”>
              <gxml:Layout Left=“20” Top=“20” Width=“5” Height=“5” Rotation=“0”/>
              <gxml:Behavior Enabled=“true” Visible=“true”/>
              <gxml:Appearance Cursor=“arrow” Transparency=“0” BackColor=“#000000”
BackStyle=“opaque”/>
            </gxml:Image>
            <gxml:Text Name=“Text1”>
              <gxml:Layout Left=“40” Top=“20” Width=“100” Height=“100” Rotation=“0”/>
              <gxml:Behavior Enabled=“true” Visible=“true”/>
              <gxml:Appearance Cursor=“arrow” Transparency=“0” BackColor=“#000000”
BackStyle=“opaque”/>
              <gxml:Data>
                <P><Font>Hello World!</Font></P>
              </gxml:Data>
            </gxml:Text>
            <gxml:Program Resource=“” SrcURL=“”>
              <MediaData>0000000000000000000000000nnn0nnn0nnn000000
              000nnn00000nnn000000000nnn0nnn0nnn00000000000000000000
              0000</MediaData64>
            </gxml:Program>
          </gxml:Scene>
        </gxml:GXML>
      </Resource>
    </Component>
  </Item>
  <Item ID=“IR_Image1”>
    <Component>
      <Resource>
        <ImageLocator>
          <InlineMedia type=“image/png”>
            <MediaData>0000000000000000000000000nnn0nnn0nnn000000
              000nnn00000nnn000000000nnn0nnn0nnn0000000000000000000
              00000</MediaData64>
          </InlineMedia>
        </ImageLocator>
      </Resource>
    </Component>
  </Item>
  </Container>
</Diddle>
```

Appendix B

This appendix shows the classes used by the program instruction code to control the playback.

```
public class Scene
{
  public final static native int getWidth( );
  public final static native int getHeight( );
  public final static native void playScene(String name);
}
public class Image
{
  public int getLeft( );
  public void setLeft(int value);
  public int getTop( );
  public void setTop(int value);
  public int getWidth( );
  public void setWidth(int value);
  public int getHeight( );
  public void setHeight(int value);
  public float getRotation( );
  public void setRotation(float value);
  public boolean getEnabled( );
  public void setEnabled(boolean value);
  public boolean getVisible( );
  public void setVisible(boolean value);
  public float getTransparency( );
  public void setTransparency(float value);
  }
public class Text
{
  public int getLeft( );
  public void setLeft(int value);
  public int getTop( );
  public void setTop(int value);
  public int getWidth( );
  public void setWidth(int value);
  public int getHeight( );
  public void setHeight(int value);
    public float getRotation( );
  public void setRotation(float value);
  public boolean getEnabled( );
  public void setEnabled(boolean value);
  public boolean getVisible( );
  public void setVisible(boolean value);
  public float getTransparency( );
  public void setTransparency(float value);
}
public class Mesh
{
  public int getLeft( );
  public void setLeft(int value);
  public int getTop( );
  public void setTop(int value);
  public int getWidth( );
  public void setWidth(int value);
  public int getHeight( );
  public void setHeight(int value);
  public float getRotation( );
  public void setRotation(float value);
  public boolean getEnabled( );
  public void setEnabled(boolean value);
  public boolean getVisible( );
  public void setVisible(boolean value);
    public float getTransparency( );
  public void setTransparency(float value);
}
public class Video
{
  public int getLeft( );
  public void setLeft(int value);
  public int getTop( );
  public void setTop(int value);
  public int getWidth( );
  public void setWidth(int value);
  public int getHeight( );
  public void setHeight(int value);
  public float getRotation( );
  public void setRotation(float value);
  public boolean getEnabled( );
  public void setEnabled(boolean value);
  public boolean getVisible( );
  public void setVisible(boolean value);
  public float getTransparency( );
  public void setTransparency(float value);
}
```

1. In a computer system, a method of encapsulating multimedia content data, multimedia content description data, and program instruction code into an aggregated data representation comprising a logical structure, the method comprising:
storing on a storage device, information about the multimedia content data, the multimedia content description data, and the program instruction code to form a main header section (300) in the logical structure;
storing on the storage device, multiple block headers for all multimedia content data, multimedia content description data, and the program instruction code to form a block headers section (301) in the logical structure; and
storing on the storage device, multiple data blocks for all multimedia content data, multimedia content description data, and the program instruction code to form a data blocks section (302) in the logical structure.

2. Method according to claim 1, wherein:
the block headers sections (301) comprise a scene block header (400);
the block headers sections (301) comprise a header selected from the group consisting of an image resource block header (500), a text resource block header (550), a mesh resource block header (600), and a video resource block header (650);
the data blocks section (302) comprise a scene data block (700);
the data blocks section (302) comprise a data block selected from the group consisting of an image resource data block (1200), a text resource data block (1250), a mesh resource data block (1300), and a video resource data block (1350);
the number of data blocks in the data blocks section (302) is equal to the number of block headers in the block headers section (301) with an empty external_link field (324); and
the program instruction code controls playback of the multimedia content.

3. Method according to claim 1, further comprising:
determining the storing order of the resources, for the different multimedia types, e.g. audio, video, image and text, providing efficient streaming transmission;
compressing the data in some of the data blocks section using appropriate compression schemes, e.g. as ZLIB, PNG or JPEG; and
providing different scaled content representations of one or more scenes, depending on different hardware profiles of the destination computers (101), e.g. bitrate, screen, language, and/or machine.

4. Method according to claim 1, wherein the logical structure is a XML formatted structure.

5. Method according to claim 1, further comprising transferring information selected from the group consisting of the aggregated data representation and the logical structure across a transport medium (105) to one or more destination computers (101).

6. Method according to claim 3, further comprising providing linking between multiple files with multimedia content by use of an external_link field (324) in the block headers section (301).

7. In a computer system, a method of retrieving multimedia content data, multimedia content description data, and program instruction code from an aggregated data representation stored on a storage device, the data representation comprising a logical structure encapsulating the multimedia content data, multimedia content description data, and program instruction code, the method comprising reading from the storage device:
a main header section (300) of the logical structure, the main header section having information about the multimedia content data, the multimedia content description data, and the program instruction code;
multiple header blocks from the header section (301) of the logical structure, the multiple block headers comprising information about multimedia content data, multimedia content description data, and program instruction code; and
multiple data blocks from the data section (302) in the logical structure, the multiple data blocks comprising multimedia content data, multimedia content description data, and program instruction code.

8. Method according to claim 7, wherein:
the block headers sections (301) comprise a scene block header (400);
the block headers sections (301) comprise a header selected from the group consisting of an image resource block header (500), a text resource block header (550), a mesh resource block header (600), and a video resource block header (650);
the data blocks section (302) comprise a scene data block (700);
the data blocks section (302) comprise a data block selected from the group consisting of an image resource data block (1200), a text resource data block (1250), a mesh resource data block (1300), and a video resource data block (1350);
the number of data blocks in the data blocks section (302) is equal to the number of block headers in the block headers section (301) with an empty external_link field (324); and
the program instruction code controls playback of the multimedia content.

9. Method according to claim 7, wherein the logical structure is a XML formatted structure.

10. Method according to claim 7, further comprising receiving information selected from the group consisting of the aggregated data representation and the logical structure across a transport medium (105) on a destination computer (101), for rendering the content using a renderer (103).

11. Computer-readable aggregated data representation encapsulating multimedia content data, multimedia content description data, and program instruction code, the aggregated data representation comprising a logical structure stored on a computer readable storage device, the logical structure comprising:
a main header section (300) comprising information about the multimedia content data, multimedia content description data, and program instruction code in a logical structure that defines the aggregated data representation;
a block header section (301) comprising multiple block headers for the multimedia content data, multimedia content description data, and program instruction code; and
a data block section (302) comprising multiple data blocks for all multimedia content data, multimedia content description data, and program instruction code.

12. Computer-readable aggregated data representation of claim 11, wherein:
the block headers sections (301) comprise a scene block header (400);
the block headers sections (301) comprise a header selected from the group consisting of an image resource block header (500), a text resource block header (550), a mesh resource block header (600), and a video resource block header (650);
the data blocks section (302) comprise a scene data block (700);
the data blocks section (302) comprise a data block selected from the group consisting of an image resource data block (1200), a text resource data block (1250), a mesh resource data block (1300), and a video resource data block (1350);
the number of data blocks in the data blocks section (302) is equal to the number of block headers in the block headers section (301) with an empty external_link field (324); and
the program instruction code controls playback of the multimedia content.

13. Computer-readable aggregated data representation of claim 11, wherein the logical structure is a XML formatted structure.

14. A computer-readable storage medium holding instructions for encapsulating multimedia content data, multimedia content description data, and program instruction code into an aggregated data representation comprising a logical structure, the instructions comprising:
storing on a storage device, information about the multimedia content data, the multimedia content description data, and the program instruction code to form a main header section (300) in the logical structure;
storing on the storage device, multiple block headers for all multimedia content data, multimedia content description data, and the program instruction code to form a block headers section (301) in the logical structure; and
storing on the storage device, multiple data blocks for all multimedia content data, multimedia content description data, and the program instruction code to form a data blocks section (302) in the logical structure.

15. A computer-readable storage medium holding instructions for retrieving multimedia content data, multimedia content description data, and program instruction code from an aggregated data representation stored on a storage device, the data representation comprising a logical structure encapsulating the multimedia content data, multimedia content description data, and program instruction code, the instructions comprising reading from the storage device:
a main header section (300) of the logical structure, the main header section having information about the multimedia content data, the multimedia content description data, and the program instruction code;
multiple header blocks from the header section (301) of the logical structure, the multiple block headers comprising information about multimedia content data, multimedia content description data, and program instruction code; and
multiple data blocks from the data section (302) in the logical structure, the multiple data blocks comprising multimedia content data, multimedia content description data, and program instruction code.
